(19) United States
(12) Patent Application Publication
(10) Pub. No.: US 2018/0072036 A1
(43) Pub. Date: Mar. 15, 2018

(54) MANUFACTURING METHOD FOR A LAYER COMPOSITE COMPRISING INTUMESCENT MATERIAL, LAYER COMPOSITE AND ENGINE PART

(71) Applicant: Rolls-Royce Deutschland Ltd & Co KG, Blankenfelde-Mahlow (DE)

(72) Inventors: Thomas KUBISCH, Koenigs-Wusterhausen (DE); Oliver KAAK, Berlin (DE)

(21) Appl. No.: 15/697,829

(22) Filed: Sep. 7, 2017

(30) Foreign Application Priority Data
Sep. 9, 2016 (DE) 10 2016 217 234.4

(51) Int. Cl. B32B 37/14

(52) U.S. Cl. CPC B32B 37/144; B32B 27/04

(57) ABSTRACT

It is provided a method for manufacturing a composite component from which an engine component can be at least partially manufactured, wherein the composite component has a multi-layer structure and at least one layer with an intumescent poriferous material as well as at least one further layer. For manufacturing the composite component at least one material layer from the intumescent and poriferous material and at least one material layer for the at least one further layer are stacked on top of each other in a tool and at least the intumescent poriferous material is impregnated by means of curing resin after the material layers have been stacked. It is provided that prior to impregnating, a pressure is applied to the material layers stacked on top of each other to compress at least the material layer of intumescent poriferous material.

### REFERENCE TO RELATED APPLICATION

This application claims priority to German Patent Application No. 10 2016 217 234.4 filed on Sep. 9, 2016, the entirety of which is incorporated by reference herein.

### BACKGROUND

The invention relates to a method for manufacturing a composite component for an engine component as well as to a composite component for manufacturing an engine component.

In the field of engines, it is common to use composite components for manufacturing engine components. Here, fiber-reinforced composite materials are used in different configurations and for different engine components in order to obtain the desired material characteristics by combining different materials. Here, a composite component (composite laminate) from which an engine component is made consists of at least two layers of different materials that are connected to each other in a firmly bonded and/or form-fit manner. What is further known in engine components is to provide these multi-layer composite components with at least one fire-retardant or fireproof layer in order to obtain a predefined fire resistance or fire retardance. Then, it is for example possible to define a sealed off area with the corresponding engine component in order to avoid or at least keep within limits a fire spreading inside the engine.

In particular in the field of construction, it is further known from fire prevention to use intumescent poriferous construction materials that swell or foam under the effect of heat, thus considerably increasing in volume in the event of fire. For example, the intumescent material serves for forming an incinerating insulation layer that inhibits the oxygen supply, and therefore the spreading of a flame. Further, a sealing of a critical area can also be achieved through the expanding intumescent material, so that a flame cannot spread further inside it. Composite components with at least one layer of an intumescent poriferous material are known from AU 2006-235991 A1 or EP 0 949 313 B1, for example.

So far, the use of intumescent material in the engine area is not common. Consequently, at this point in time there are at best rudimentary considerations of manufacturing a composite component with at least one layer containing intumescent material in a manner that is as compact and simple as possible, so that its use in the field of engines is practically facilitated.

### SUMMARY

The invention is thus based on the objective to provide a composite component for creating an engine component that is improved with respect to the requirements in the field of engines.

This objective is achieved through a manufacturing method with features as described herein as well as a composite component with features as described herein.

In a manufacturing method according to the invention, it is provided that for manufacturing a multi-layer composite component
at least one material layer made of an intumescent poriferous material and at least one further material layer for at least one further layer of the composite component are stacked on top of each other in a tool, and
at least the intumescent poriferous material is impregnated by means of curing resin after the material layers have been stacked.

It is further provided according to the invention that
prior to impregnating, a pressure is applied to the material layers stacked on top of each other to compress at least the material layer of intumescent poriferous material, and
the material layer of the intumescent poriferous material is kept in its compressed shape and is sealed against the entry of any liquid in the composite component by means of the curing resin.

According to one variant of the invention, an autoclave is used as a tool by means of which a pressure for compressing at least the material layer of intumescent poriferous material onto the material layers stacked on top of each other is applied. For instance, a manufacturing process provided herein can in particular be an autoclave cycle in which the pressure provided for compressing the intumescent material is applied already early on, prior to the heating of the material layers stacked on top of each other.

According to a further variant of the invention, the resin provided for impregnation can be provided in the form of a separate material layer in the material layers stacked on top of each other. Here, the resin is for example provided as a comparatively thin layer between a material layer of intumescent material and a further material layer of a composite material. During the subsequent heating and compression, the resin then enters the intumescent material and the composite material, connecting them. Such a method can for example be realized in an autoclave.

According to another variant of the invention, for a firmly bonded connection of the material layers stacked on top of each other, at least one bonding agent layer is provided. This bonding agent layer can contain a—possibly additional—resin that is used at least partially for impregnating the intumescent material.

Thus, the invention is based on the basic idea to make use of the poriferous, possibly also porous, characteristics of an intumescent material so as to impregnate it in a compressed shape with a resin or a resin mass, and to thus form a composite component to be manufactured from an intumescent material with a reduced wall thickness. On the one hand, the supplied resin serves for increasing the rigidity and resilience of the layer with the intumescent poriferous material within the composite component, and to connect the layer with the intumescent material to the at least one further layer in a firmly bonded manner. On the other hand, in the solution according to the invention, the material layer of the intumescent material is conserved and sealed in its compressed shape within the composite component through the cured resin.

By using an intumescent poriferous material it is ensured that the introduced resin or the introduced resin mass can be absorbed by the poriferous or porous intumescent material, and thus the intumescent material is imbued by the resin and can be sealed after the resin has cured. Then, a sealed layer, which is resistant to the effects of fluid, can be formed at the engine component by means of the intumescent material sealed by the resin. The intumescent material can for example have a porosity of more than 70%, in particular in the range of more than 85% or approximately 90%. In the unprocessed state, the intumescent material is for example present in a felt-like manner as a material layer made of a fiber fleece material. For example, a material layer of Tecnofire® by Technical Fibre Products Ltd. is used.

In a composite component manufactured according to the invention, in the event of fire or if a temperature exceeds as critical threshold value, the resin degasses from the intumescent material or vaporizes, thus releasing the intumescent material, so that it can swell or foam in order to have a fire-inhibiting or fire-retardant effect. Here, a first increase in the volume of the layer with the intumescent material is allowed already by the degassing resin, as the resin does no longer keep the layer in its compressed shape. A temperature-driven increase in volume of the intumescent material occurs simultaneously or subsequently to the degassing of the resin or to the vaporization or combustion of the resin. In this manner, a controlled flame treatment can for example be achieved through the degassing resin, with the material of the composite component is imbued with resin burning off similar to a candle before a barrier is subsequently created by the (further) swelling or foaming of the intumescent material, which counteracts a further spreading of the flames. Here, the layer with the intumescent material acts as a heat shield in the event of fire or already if a temperature exceeds a critical threshold value.

Through the compression of at least the material layer of the intumescent poriferous material that is provided according to the invention, it is further achieved that a smaller amount of resin is required for sealing it. This is also regularly associated with an outer layer of the composite component containing less resin, since in the material layer of the intumescent material usually forms an outer layer on the side that is to be fire-protected in the finished composite component. This can be advantageous with respect to a required strength and stiffness of the engine component that is made of the composite component, in particular because in this way only a comparatively thin layer with intumescent material has to be used, and the available installation space can be used for the other, in that case structure-supporting, layers.

In one embodiment variant, the at least one further layer or material layer for forming the composite component is formed by a composite material. For example, what is provided here is a material layer for the further layer in the form of a prepreg, i.e., a pre-impregnated semi-finished textile fiber matrix product. Alternatively or additionally, a layer from a different fiber-reinforced material can be provided.

In one embodiment variant of a method according to the invention, a heating of the material layers stacked on top of each other up to at least a minimum temperature is provided for the impregnation with the resin. Here, the heating is realized for example by heating a reception space of the tool that receives the material layers stacked on top of each other. This reception space is defined by a cavity in a mold shell or by an autoclave, for example. The heating for example serves for keeping the introduced resin in a liquid form or for curing the resin if it is a heat-curing resin.

At this point, it should already be mentioned that the introduction of the resin can for example be realized through a separate resin layer that is provided in the material layers stacked on top of each other. Alternatively, an injection of the resin can for example be performed by way of a resin transfer molding (RTM) or in a vacuum-assisted manner by way of a VARI or VARTM method (short for “vacuum assisted resin injection” or “vacuum assisted resin transfer molding”). Alternatively or additionally, if a pre-impregnated prepreg is used, the resin contained therein can be liquefied in the course of the manufacture of the composite component by applying pressure and heating, and then can (also) be used for impregnation of the compressed intumescent material that is layered thereon.

In one embodiment variant, heating up the material layers stacked on top of each other to a minimum temperature of approximately 70° C. is provided for the impregnation to achieve that the resin or the resin mass imbues the compressed intumescent material to a sufficient extent. In the further manufacturing process, it can be provided that the temperature is subsequently increased stepwise up to a first maximum temperature of approximately 120° C., and subsequently up to a second maximum temperature of approximately 175° C. A defined dwell time for the first maximum temperature, for example of 120° C., serves for providing tension equalization during the curing process, since it is to be ensured that the tool and the composite component have a sufficient temperature before the actual curing is performed by means of the increase up to a second maximum temperature.

To ensure that the intumescent material is already densified to a desired thickness before the resin enters the intumescent material, it is provided in one variant that the pressure for compressing at least the material layer of intumescent poriferous material is applied before the minimum temperature of for example 70° C. is reached. For this purpose, the pressure can be applied when a heating appliance for heating the material layers stacked on top of each other to the minimum temperature is activated, or before such a heating appliance is activated. The provided (compression) pressure is thus applied at that point in time or shortly after that point in time when the heating appliance is activated and a heating process is thus initiated. Just like with a downstream activation of the heating appliance, it is ensured in this way that the prescribed pressure acts on the material layers in any case already before the minimum temperature has been reached.

In one embodiment variant, the provided (compression) pressure for compressing at least the material layer of intumescent material lies in the range of 5 to 8 bar, in particular in the range of 5.5 to 7.5 bar. For example, a pressure of approximately 7 bar is provided.

Alternatively or additionally, the at least one material layer for the at least one further layer of the composite component can be pre-impregnated, and thus the resin that is provided for impregnating the intumescent poriferous material can at least partially come from the pre-impregnated material layer. What may be particularly advantageous in this context is the previously explained variant in which the (compression) pressure for compressing at least the material layer of the intumescent material is applied early on, before the material layers stacked on top of each other is performed. By applying the pressure early on, a resin for conserving the compressed shape of the intumescent material and for sealing it can be provided in a comparatively small amount, and can be introduced into the intumescent material already early on, before a liquefaction of the (additional) resin from the pre-impregnated support material occurs as a result of subsequent heating. In this manner, a possibly undesired intermixing of different resins and thus resin systems inside the composite component can be effectively avoided.

For example, the used intumescent poriferous material can be chosen in such a manner and the pressure applied thereto can be set to be so high that a layer with the intumescent poriferous material does not exceed a thickness of 2.3 mm in the manufactured composite component. In particular, a (layer) thickness lies in the range of 0.4 mm to 1.5 mm, for example. The layer of compressed intumescent material is thus comparatively thin, and is, as it were, locked and “frozen” in its compressed state by being bound by means of the resin. However, due to the intumescent properties of the material, this layer can swell to reach a multiple of its volume so as to form a fire-retardant barrier.

A further aspect of the solution according to the invention is the provision of a composite component from which an engine component can be at least partially manufactured.

Here, a composite component according to the invention is comprised of multiple layers and has at least one layer with an intumescent poriferous material as well as at least one further layer, for example from a composite material. For creating the layer with the intumescent poriferous material, a material layer of intumescent poriferous material is impregnated by means of a resin, which, in its cured state, keeps the material layer of intumescent poriferous material in a compressed shape and seals it off against the entry of any liquids, but also against the entry of moisture and gasses, within the composite component.

Thus, a composite component according to the invention can be manufactured by means of a manufacturing method according to the invention. Accordingly, the advantages and features of embodiment variants of a manufacturing method according to the invention, as they are mentioned above or in the following, also apply to variants of a composite component according to the invention, and in reverse.

A composite component manufactured according to the invention serves for manufacturing an engine component for a gas turbine engine, for example. Such an engine component can for instance be an engine housing (also referred to as a “nacelle”), a fan housing, a wall of a bypass channel, or a cladding component for housing at least one conduit and/or an electronic component and/or a component conducting fluid, and/or an assembly group inside the engine.

### BRIEF DESCRIPTION OF THE DRAWINGS

Possible embodiment variants of the solution according to the invention are illustrated by way of example based on the accompanying Figures.

FIG. 1 shows, in a schematic manner and in a cross-sectional view, a gas turbine engine in the form of a turbofan engine, with a composite component (composite laminate) manufactured according to the invention being used at its engine components.

FIG. 2 shows a more detailed rendering of the engine of FIG. 1 in perspective view, without the illustration of an engine housing.

FIGS. 3A-3C show, in a schematic manner, different embodiments of a manufacturing method according to the invention, illustrating different material layers for manufacturing a multi-layer composite component.

FIG. 4 shows a diagram in which a temperature development and a pressure development are indicated over time for a variant of a manufacturing method according to the invention that is performed with an autoclave.

FIG. 5 shows, in a schematic manner, a further embodiment variant of a manufacturing method according to the invention, in which a separate resin layer between a material layer of intumescent material and a material layer of a composite material is used for creating a composite component.

### DETAILED DESCRIPTION

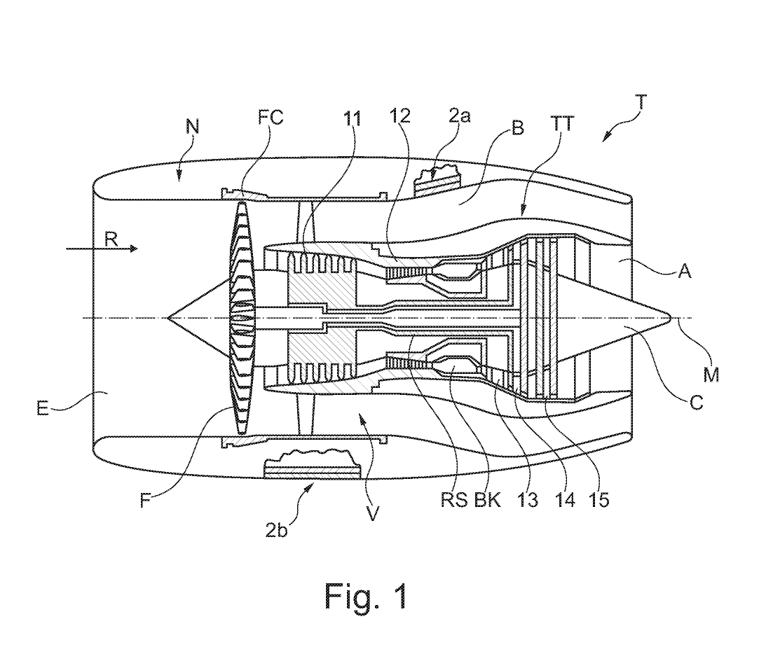

FIG. 1 illustrates, in a schematic manner and in sectional view, a (turbofan) engine T in which the individual engine components are arranged behind each other along a rotational axis or central axis M. At an inlet or intake E of the engine T, air is sucked in along an entry direction R by means of a fan F. This fan F, which is arranged in a fan housing FC, is driven via a rotor shaft RS that is set into rotation by a turbine TT of the engine T. Here, the turbine TT connects to a compressor V, which for example has a low-pressure compressor 11, and a high-pressure compressor 12, as well as possibly also a medium-pressure compressor. The fan F supplies air to the compressor V, on the one hand, as well as, on the other hand, to the secondary flow channel or bypass channel B for creating a thrust. Here, the bypass channel B extends about a core engine that comprises the compressor V and the turbine TT as well as a primary flow channel for the air that is supplied to the core engine by the fan F. Towards the outside, the bypass channel B is delimited by an engine housing N which is usually referred to as a nacelle.

The air that is conveyed via the compressor V into the primary flow channel reaches a combustion chamber section BK of the core engine, where the driving power for driving the turbine TT is generated. For this purpose, the turbine TT has a high-pressure turbine 13, a medium-pressure turbine 14, and a low-pressure turbine 15. Here, the turbine TT drives the rotor shaft RS and thus the fan F by means of the energy released during combustion in order to create the required thrust by means of the air that is conveyed into the bypass channel B. The air from the bypass channel B as well as the exhausts from the primary flow channel of the core engine are discharged via an outlet A at the end of the engine T. Here, the outlet A usually has a thrust nozzle with a centrally arranged outlet cone C.

Based on FIG. 1 it is illustrated by way of example in the area of the engine housing N how a wall delimiting the bypass channel B and/or an outer shell surface of the engine housing N is constructed by means of a multi-layer composite component 2a or 2b. At that, a wall that delimits the bypass channel B can be provided with a fire-retardant or fireproof layer for avoiding the spreading of flames in the event that a fire occurs inside the engine T. The same applies to a casing of the core engine that is located further radially inwards. Here, too, in particular parts of the housing are manufactured from a composite component and thus from a composite material, wherein such a composite component usually has at least one layer of a fireproof or at least fire-retardant material.

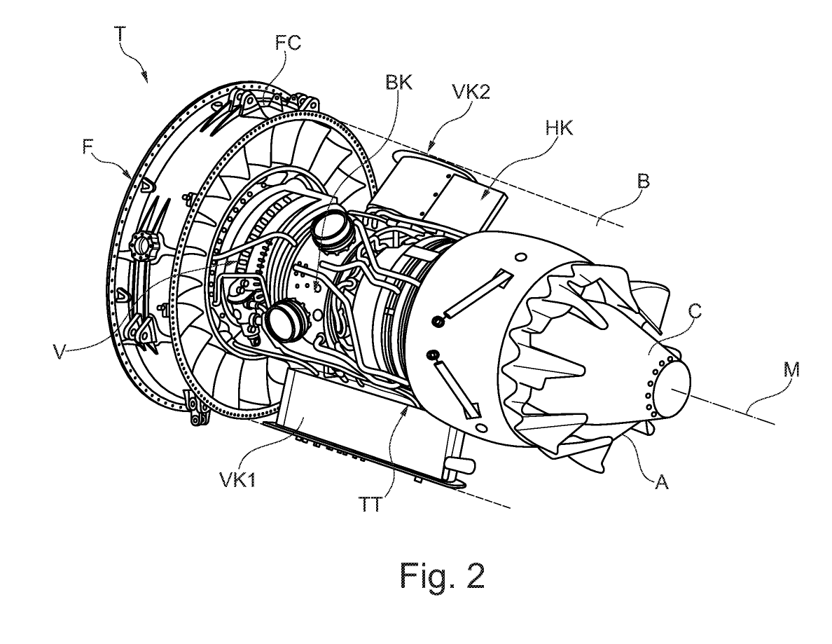

Based on FIG. 2, in which the engine T of FIG. 1 is shown in perspective rendering in a more detailed manner and without the engine housing N, further engine components that can be manufactured from a composite component with at least one fireproof or fire-retardant layer are illustrated by way of example. Here, it may for example be referred to the fan housing FC of the fan F, as well as to claddings VK1 and VK2 that are located inside the bypass channel B. For instance, conduits and/or electronic components are housed in an aerodynamic manner by means of claddings VK1 and VK2. For example, for this purpose a cladding component VK2 forms a trailing edge HK that is tapered in the flow direction of the fluid that is flowing inside the bypass channel B during operation of the engine. The cladding components VK1 and VK2 are usually referred to as “fairings” or “splitter fairing”.

Alternatively or additionally to the above-mentioned engine components, it is also possible to manufacture claddings or housings that are accommodated inside a hollow space inside the engine housing N from a composite component that is provided with a fireproof or fire-retardant material for the purpose of fire prevention.

In principle, it is desirable to design all composite component in the engine area with thin walls and above all so as to have a low weight, of course without having to forego effective fire prevention. In this context, the solution according to the invention proposes to manufacture a composite component, such as for example the composite component 2a or 2b, with an intumescent poriferous material, and in addition to manufacture them by means of a method in which a material layer of intumescent poriferous material is impregnated in its compressed shape with a resin, and is held and sealed in that compressed shape.

By using an intumescent material, at least one layer, which increases by a multiple of its original volume if a temperature exceeds a threshold value (e.g. of 195° C.), and in particular in the event of a fire inside the engine T, and in this manner provides an insulating layer in the kind of a heat shield, and/or closes areas off in a targeted manner due to its increase in volume, so that a flame cannot easily spread into these areas, is provided in a composite component, which preferably integrates multiple composite materials.

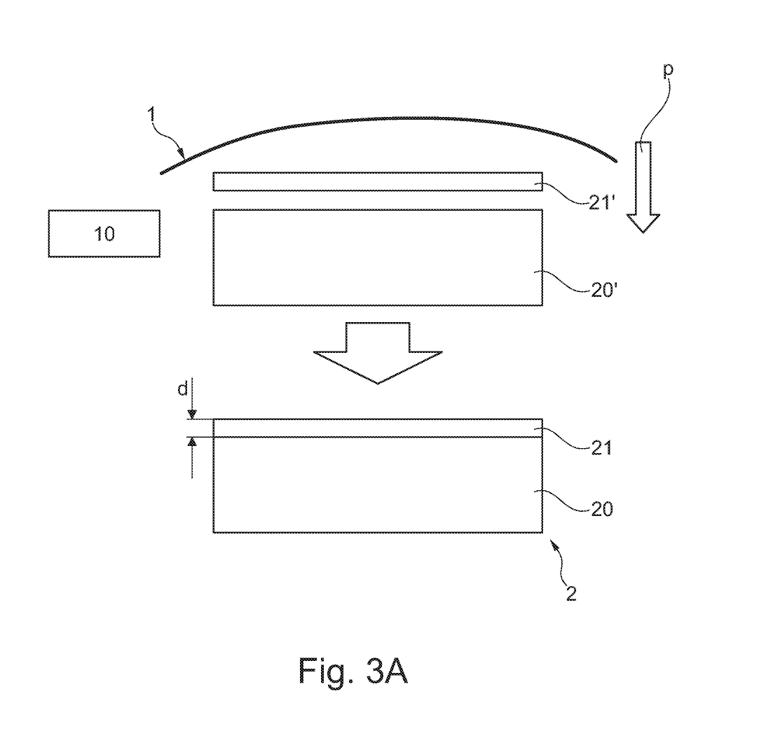

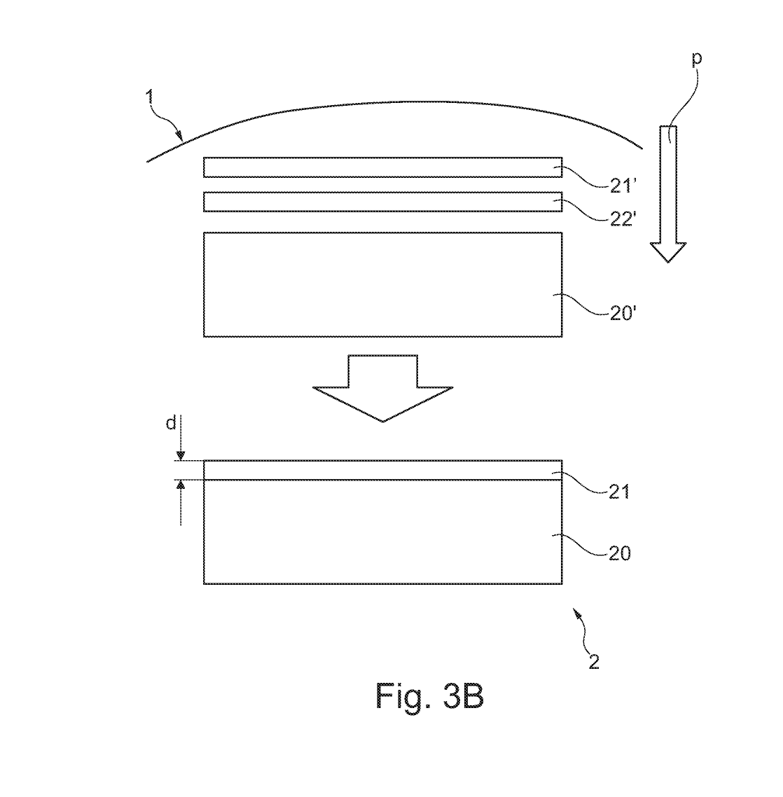

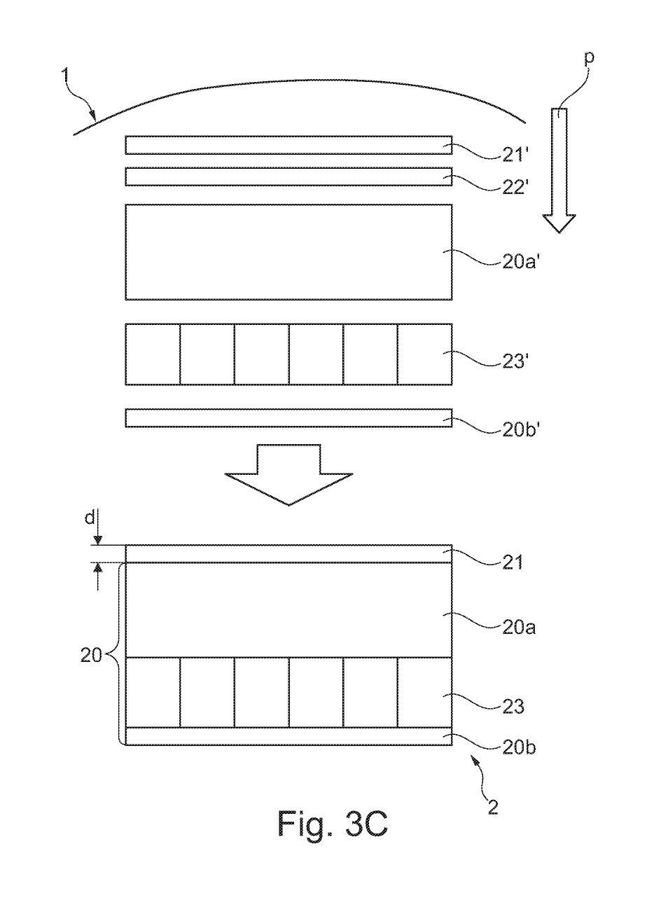

Here, it is provided in one manufacturing variant illustrated based on FIG. 3A, that a material layer 21′ of intumescent material is placed inside a tool 1 onto a composite material layer 20′, for example with a fiber reinforcement. Subsequently, an increased pressure p is applied by means of the tool 1 to compress the material layers 20′ and 21′ that are stacked on top of each other. At that, in particular the material layer of intumescent material 21′ is compressed.

Subsequently, a resin is introduced via a resin supply 10 of the tool 1 for impregnating the compressed material layers 20′ and 21′. In particular the preferably highly poriferous intumescent material of the material layer 21′ is respectively filled with the resin, so that not only the two material layers 20′ and 21′ are connected to each other through the resin in a firmly bonded manner, but also the material layer 21′ of the intumescent material is held in its compressed shape and sealed. The cured resin thus conserves the compressed shape of the intumescent material and seals it towards the outside against the entry of any liquids. The introduction of the resin via the resin supply 10 is for example realized in the kind of a resin injection method (RTM methods) or in a vacuum-aided manner in a VARI or VARTM method.

For instance, Tecnofire® by Technical Fibre Products Ltd. is suitable for providing a material layer 21′ of an intumescent highly poriferous material. But generally, also other intumescent materials are suitable, in particular such materials that are present in a felt-like manner and in the form of a flexible fiber fleece material.

In a manufacturing method performed corresponding to the variant of FIG. 3A, what is obtained in the end is a composite component 2 in which multiple layers 20 and 21 are present in an interconnected manner. Here, a composite material layer 20, which is usually also referred to as a composite laminate, is provided for providing the desired structural characteristics, such as stiffness and strength. The at least one additional layer 21 with the compressed intumescent material serves for fire prevention. This layer 21 is comparatively thin-walled and has only a (layer) thickness of less than 2 mm, for example a thickness in the range of 0.4 mm to 1.5 mm.

If a temperature exceeds a threshold value, for example of approximately 195° C., in the area of the layer 21 that is provided with the intumescent material, or if flames occur in this area, the cured resin of the composite component 2 degasses. In that case, the intumescent material of layer 21 is no longer retained in its compressed shape by the resin and can (additionally) swell or foam under the effect of the temperature. The associated increase in volume of the layer 21 that is provided with the intumescent material can serve as a fire-retardant or fireproof barrier in the kind of a heat shield. Alternatively or additionally, an area of the engine T can be sealed off through the increase in volume, depending on which engine component is manufactured from the composite component 2.

In the variant of FIG. 3B, a separate bonding agent layer 22′ is used for impregnating and sealing the compressed material layer 21′ from intumescent poriferous material. This bonding agent layer 22′ is provided during manufacturing of the composite component 2 between the material layer 21′ of intumescent material and the composite material layer 20′. Through the pressure p applied by means of the tool 1 as well as the corresponding heating, the resin of the bonding agent layer 22′ enters the compressed material layer 21′ of the intumescent material, and at the same time ensures a firmly bonded connection between this material layer 21′ and the composite material layer 20′. Thus, the composite component 2 is manufactured by means of the bonding agent layer 22′ by way of a so-called wet-on-wet bonding or co-curing or co-bonding with the different material layers 20′ and 21′. By applying the pressure p—for example of approximately 7 bar—already at an early stage, a compression of the intumescent material is obtained early on, whereby the amount of resin for impregnating it can be kept comparatively low.

In the variant of FIG. 3C, a honeycomb layer 23′ is provided in addition to the bonding agent layer 22′. This honeycomb layer 23′ serves for creating a honeycomb structure layer 23 with multiple honeycombs that are located next to each other in the composite component 2 to be manufactured. Through such a honeycomb structure layer 23, e.g. an improved noise reduction can be achieved, whereby a correspondingly manufactured composite component is particularly suitable for manufacturing an inner surface of an engine housing N. Here, the honeycomb layer 23′ is provided between two separate composite material layers 20a′ and 20b′, with the bonding agent layer 22′ being provided between the one separate composite material layer 20a′ and the material layer 21′ of intumescent material.

In all three previously explained variants of FIGS. 3A, 3B and 3C, a composite component 2 is provided in which an outer layer 21 with intumescent material is present in a compressed and sealed shape due to the cured resin. In addition, the comparatively thin layer 21 with intumescent material is comparatively rigid due to the cured resin, while the originally used material layer 21′ is still flexible and is for example provided in the form of a fiber fleece material.

Incidentally, it is remarkable that when using a pre-impregnated composite material layer 20′ or 20a′, 20b′, it can be achieved by means of an early application of the pressure p that the resin provided for the impregnation of the compressed intumescent material does either not intermix or barely intermixes with a resin that is used for the pre-impregnation of the respective composite material layer 20′ or 20a′, 20b′.

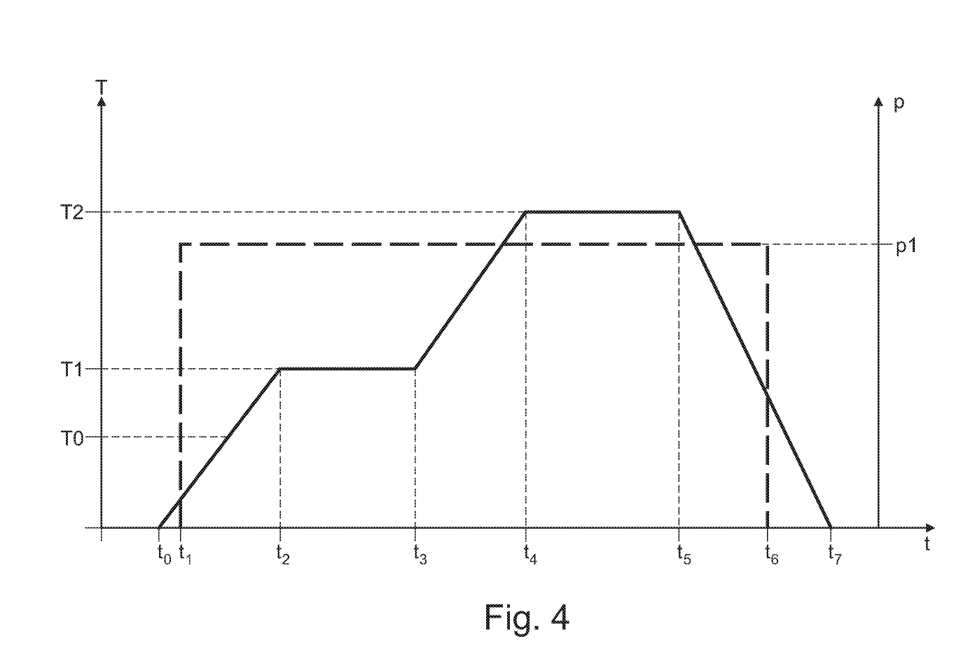

By way of example, the diagram of FIG. 4 illustrates temperature and pressure developments for a manufacturing process by means of which a composite component 2 is obtained from material layers that are stacked on top of each other. In the diagram of FIG. 4, a temperature T as well as a pressure p is indicated over time t. Here, FIG. 4 illustrates an autoclave process for manufacturing a composite component 2, for example.

Already at the beginning of the manufacturing processes that is illustrated based on FIG. 4, a heating appliance is started up at a point in time t₀, and thus the temperature inside the autoclave that serves as a tool 1 is progressively increased. For compressing the material layers that are stacked on top of each other and in particular the material layer 21′ of intumescent poriferous material, a (compression) pressure p1 above an ambient pressure is generated as the heating appliance is activated. Here, the pressure p1 is already applied at a point in time t₁, before the temperature exceeds a minimum threshold value TO at which the resin, which is either liquefied or kept liquid, begins filling the pores of the compressed intumescent material.

The pressure p1 applied to the material layers that are stacked on top of each other is maintained over a greater part of the manufacturing cycle within a time period t₁ to t₆, in which the temperature is at first increased up to a first maximum temperature T1>T0, with T1≈120° C. Here, the corresponding temperature level is maintained for a time period t₂ to t₃, before in a next step the temperature is increased (point in time t₄>t₃) once more to an even higher maximum temperature T2, with T2≈175° C., and this increased temperature level is maintained up to a point in time t₅. After that, a slow cooling process until a point in time t₇ is allowed, wherein the pressure p is also lowered back to ambient pressure in the interim period. Thus, in the variant of FIG. 4, the (compression) pressure p1 is applied over the entire time period t₀ to t₅ in which the temperature T is increased stepwise up to the second maximum temperature T2, and thus in particular before the temperature has exceeded a minimum temperature of ≈70° C. A defined dwell time (t₃-t₂) for the first maximum temperature, for example of T1≈120° C., serves for providing tension equalization during the curing process, since it is to be ensured that the tool and the composite component have a sufficient temperature before the actual curing is performed by increasing to a second maximum temperature T2≈175° C.

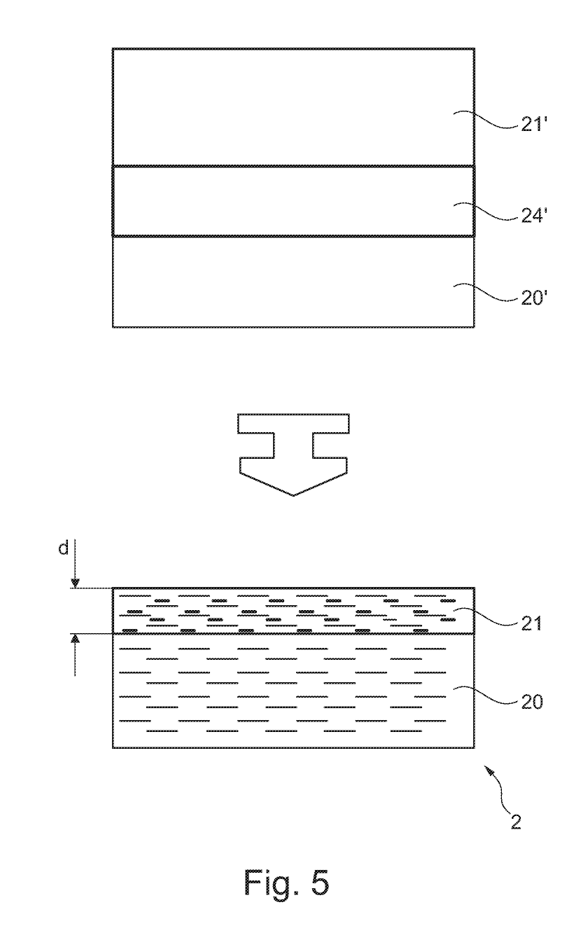

FIG. 5 illustrates once more, in a schematic manner, a variant for manufacturing a composite component 2 based on the temperature and pressure developments of FIG. 9. At that, a resin layer 24′ (analogously to the bonding agent layer 22′) is for example inserted in the kind of a thin film between a felt-like material layer 21′ of an intumescent poriferous material, such as e.g. Tecnofire®, and a composite material layer 20′. At that, any intermixing of the resin of the resin layer 24′ with a resin from a possibly pre-impregnated prepreg of the composite material layer 20′ is excluded, or is extremely minor, occurring only at the edge of the material layers 20′ and 21′. Thus, at an outer shell surface, the composite component 2 manufactured in this manner, from which an engine component is subsequently manufactured, has only a thin layer 21 with intumescent material as well as resin sealing and stabilizing the same, having a thickness d≦2 mm. At that, the cured resin is homogenously distributed within the layer 21 with intumescent material, and is present in the composite material layer 20 only at an edge that adjoins the layer 21 with intumescent material.

In the previously explained embodiment variants, the material layer 21′ of intumescent material is densified to approximately ⅓ or ¼ of its original thickness, for example through the applied pressure p1, before the stabilizing resin is introduced. Here, the previous compression of the material layer 21 from intumescent material has proven to be particularly advantageous if different resins with different viscosities are used in the different material layers 20′, 20a′, 20b′, 22′, 23′ and 24′. What is particularly achieved through the early compression is that the different resins barely intermix or do not intermix at all, and especially that the resin provided for sealing and stabilizing the compressed intumescent material is significantly present within the manufactured composite component 2 only in the layer 21 with the intumescent material.

Parts List

1 tool/autoclave

10 resin supply

11 low-pressure compressor

12 high-pressure compressor

13 high-pressure turbine

14 medium-pressure turbine

15 low-pressure turbine

2, 2a, 2b composite component

20 composite material layer/composite laminate

20′ composite material layer/prepreg

20a, 20b separate composite material layer

20a′, 20b′ separate composite material layer

21 layer with intumescent material

21′ material layer from intumescent material

22′ bonding agent layer

23 honeycomb structure layer

23′ honeycomb layer

24′ resin layer

A outlet

B bypass channel

BK combustion chamber section

C outlet cone

d thickness

E inlet/intake

F fan

FC fan housing

HK trailing edge

M central axis/rotational axis

N engine housing

p (compression) pressure

R entry direction

RS rotor shaft

T turbofan engine

TT turbine

U circumferential direction

V compressor

VK1, VK2 cladding

1. A method for manufacturing a composite component from which an engine component can be at least partially manufactured, wherein the composite component has a multi-layer structure and at least one layer with an intumescent poriferous material as well as at least one further layer, wherein for manufacturing the composite component
at least one material layer from intumescent poriferous material and at least one material layer for the at least one further layer are stacked on top of each other in a tool, and
at least the intumescent poriferous material is impregnated by curing resin after the material layers have been stacked, wherein
a pressure is applied to the material layers stacked on top of each other prior to the impregnation so as to compress at least the material layer of the intumescent poriferous material,
the material layer of intumescent poriferous material is held in its compressed shape and sealed against the entry of any liquid in the composite component by the curing resin, and
an autoclave is used as the tool by which the pressure for compressing at least the material layer of the intumescent poriferous material is applied to the material layers stacked on top of each other.

2. The method according to claim 1, wherein heating of the material layers stacked on top of each other up to at least a minimum temperature is carried out for performing the impregnation with the resin.

3. The method according to claim 2, wherein the pressure for compressing at least the material layer of the intumescent poriferous material is applied before the minimum temperature is reached.

4. The method according to claim 2, wherein the pressure for compressing at least the material layer of the intumescent poriferous material is applied when a heating appliance is activated for heating the material layers stacked on top of each other to the minimum temperature, or before the heating appliance is activated.

5. (canceled)

6. (canceled)

7. The method according to claim 1, wherein the at least one material layer for the at least one further layer is pre-impregnated, and the resin provided for impregnating the intumescent poriferous material comes at least partially from the pre-impregnated material layer.

8. (canceled)

9. (canceled)

10. (canceled)

11. The method according to claim 1, wherein the layer with the intumescent poriferous material does not exceed a thickness of 2.3 mm in the manufactured composite component.

12. The method according to claim 11, wherein the layer has a thickness in the range of 0.4 mm to 1.5 mm.

13. (canceled)

14. A composite component from which an engine component can be at least partially manufactured, wherein the composite component has a multi-layer structure and at least one layer with an intumescent poriferous material as well as at least one further layer, wherein at least the intumescent poriferous material is impregnated through a curing resin, wherein a material layer of the intumescent poriferous material is kept in a compressed shape and sealed against the entry of any liquid by the curing resin to form the layer with the intumescent poriferous material in the composite component, the composite component manufactured by the method according to claim 1.

15. An engine component for a gas turbine engine that is at least partially manufactured from a composite component according to claim 14.

16. The engine component according to claim 15, wherein the engine component is an engine housing, a fan housing, a wall of a bypass channel, or a cladding component for housing at least one conduit and/or an electronic component and/or a component conducting a fluid and/or assembly group inside the engine.

17. A method for manufacturing a composite component from which an engine component can be at least partially manufactured, wherein the composite component has a multi-layer structure and at least one layer with an intumescent poriferous material as well as at least one further layer, wherein for manufacturing the composite component
at least one material layer from intumescent poriferous material and at least one material layer for the at least one further layer are stacked on top of each other in a tool, and
at least the intumescent poriferous material is impregnated by curing resin after the material layers have been stacked, wherein
a pressure is applied to the material layers stacked on top of each other prior to the impregnation so as to compress at least the material layer of the intumescent poriferous material,
the material layer of intumescent poriferous material is held in its compressed shape and sealed against the entry of any liquid in the composite component by the curing resin, and
the resin provided for impregnation is provided as a separate material layer in the material layers stacked on top of each other.

18. The method according to claim 11, wherein a separate resin layer is provided between the at least one material layer from intumescent poriferous material and the at least one material layer.

19. A method for manufacturing a composite component from which an engine component can be at least partially manufactured, wherein the composite component has a multi-layer structure and at least one layer with an intumescent poriferous material as well as at least one further layer, wherein for manufacturing the composite component
at least one material layer from intumescent poriferous material and at least one material layer for the at least one further layer are stacked on top of each other in a tool, and
at least the intumescent poriferous material is impregnated by curing resin after the material layers have been stacked, wherein
a pressure is applied to the material layers stacked on top of each other prior to the impregnation so as to compress at least the material layer of the intumescent poriferous material,
the material layer of intumescent poriferous material is held in its compressed shape and sealed against the entry of any liquid in the composite component by the curing resin, and
at least one bonding agent layer is provided in the material layers stacked on top of each other.

20. The method according to claim 13, wherein the at least one bonding agent layer contains a resin, and a resin coming at least partially from the bonding agent layer is provided for impregnating the intumescent poriferous material.
